(19) United States
(12) Patent Application Publication
(10) Pub. No.: US 2013/0283748 A1
(43) Pub. Date: Oct. 31, 2013

(54) INNER ROW TRUSS FOR ROW CROP COMBINE HEADER

(71) Applicant: AGCO CORPORATION, Duluth, GA (US)

(72) Inventors: Jeffrey S. Funk, Hillsboro, KS (US); Randy Lohrentz, Buhler, KS (US)

(21) Appl. No.: 13/727,947

(22) Filed: Dec. 27, 2012

Related U.S. Application Data
(60) Provisional application No. 61/580,736, filed on Dec. 28, 2011.

(51) Int. Cl. A01D 47/00

(52) U.S. Cl. CPC A01D 47/00
USPC 56/119

(57) ABSTRACT

A harvesting header for a row crop machine has a tool bar with a plurality of row units attached thereto. Each row unit has a base and a pair of elongated row unit arms extending from the tool bar. The row unit arms form a stalk-receiving slot between facing inner sides of the pair of row unit arms. The row unit arms have outer sides facing away from the stock-receiving slot. The header has inner row braces, with each brace positioned forward of the tool bar and between an adjacent pair of row units. A first side of the inner row brace is attached to one of the outer sides of one of the row unit arms, and an opposing side of the inner row brace is attached to one of the outer sides of one of the row unit arms of an adjacent row unit.

### CROSS REFERENCE TO RELATED APPLICATIONS

This application claims priority to U.S. Provisional Application No. 61/580,736 filed Dec. 28, 2011, entitled “INNER ROW TRUSS FOR ROW CROP COMBINE HEADER”.

### BACKGROUND OF THE INVENTION

1. Field of Invention

This invention relates to a harvesting header for a combine harvester, and more particularly, to a header having brace members between header row units.

2. Description of Related Art

Agricultural harvesters such as combines are typically equipped with a harvesting header. For example, corn headers are specifically designed to pick corn and vary in size from two-row units to twelve-row units or more. As the harvester moves through the field, each row-unit passes between rows of corn. Corn header row units typically use gathering chains to covey crop material and ears rearward toward a cross auger. A set of driven snap rolls, which rotate based on the speed of the harvester, grabs the corn stalks and forces them downward between stripper plates. The ears of corn are snapped free of the stalk and the cross auger passes the ears to the feeder housing of the harvester. If the snap rolls are operated too fast or too slow, ears of corn may be lost or entire corn stalks may be passed to the cross auger and feeder housing.

Over the years, the width of harvesting headers has increased in order to reducing the number of passes through the field required by the harvesting machine to cover the entire field. However, as the width of headers increases, the amount of flexing of the structure of the header which occurs has also increased. This has resulted in increased difficulties in maintaining the tool bar in a straight orientation for proper operation. Headers are typically supported by the harvesting machine at a location in the middle of the header. As the header passes through the field, the ends of the header tend to deflect rearward from forces applied to the ends of the header. As headers increase in width, it is harder to prevent this deflection.

Header manufacturers have taken various approaches to address this problem. One approach is to make the tool bar more robust. However, adding material to the toolbar does not always strengthen the toolbar in the desired direction and adds weight and expense to the header.

### OVERVIEW OF THE INVENTION

In one embodiment, the invention is directed a harvesting header for use with a row crop harvesting machine. The harvesting header has a tool bar extending across the full width of the header and a plurality of row units attached to the tool bar. Each row unit has a base and a pair of elongated row unit arms extending from said tool bar. The row unit arms forms a stalk-receiving slot between facing inner sides of the pair of row unit arms. The row unit arms also have outer sides facing away from the stock-receiving slot. The header also has a plurality of inner row braces. Each inner row brace is positioned forward of the tool bar and between an adjacent pair of said plurality of row units. A first side of the inner row brace is attached to one of the outer sides of one of the row unit arms of one of the plurality of row units, and an opposing side of the inner row brace is attached to one of the outer sides of one of the row unit arms of an adjacent row unit. The plurality of inner row braces and plurality of row units form a continuous supporting structure for the tool bar having a path through an inner row brace, a first row unit arm, the row unit base and the other row unit arm of a first row unit, a second inner row brace, and the row unit arm, row unit base and other row unit arm of a second row unit.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a harvester header for use with a harvesting machine;

FIG. 2 is a front perspective view of the harvesting header of FIG. 1 with parts broken away to reveal internal details of the row units;

FIG. 3 is an enlarged perspective view of a portion of the harvesting header of FIG. 2 showing brace members between the row units; and.

FIG. 4 is a perspective view of the underside portion of the harvesting header of FIG. 2 further illustrating the brace members.

Corresponding reference characters indicate corresponding parts throughout the views of the drawings.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “front”, “rear”, “left” and “right”, are made as viewed from the side of the combine.

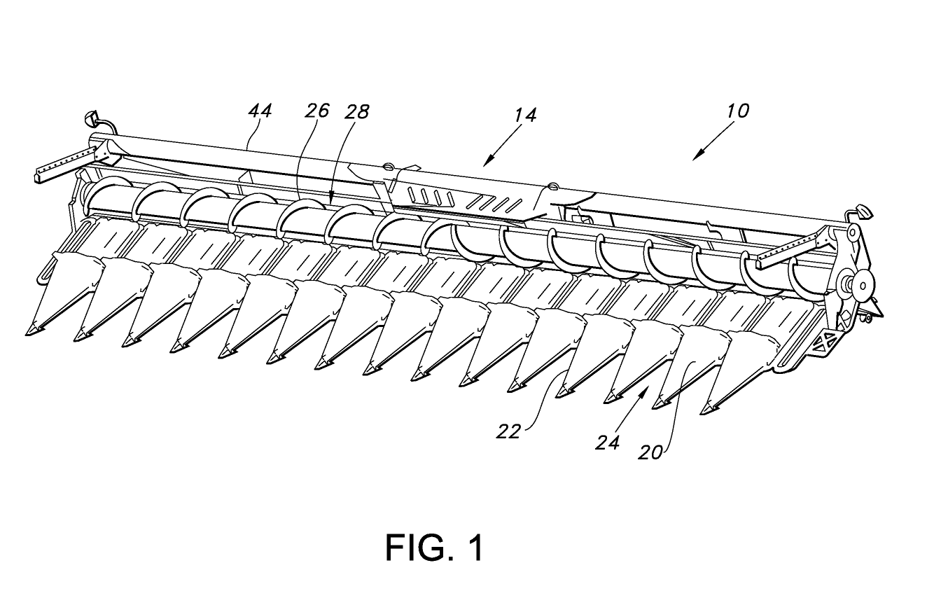

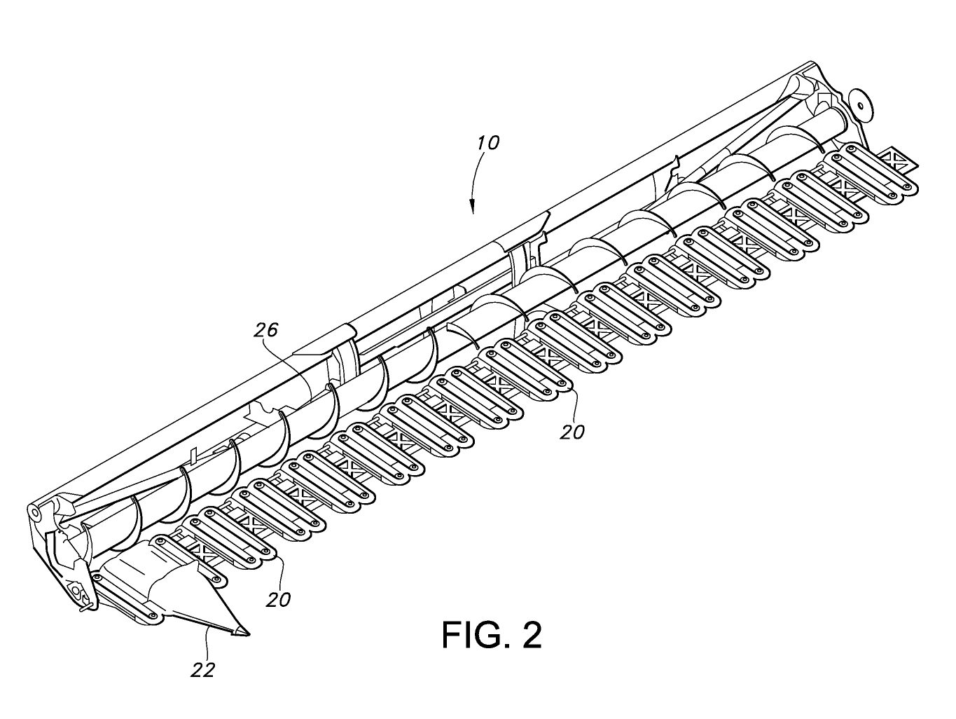

Referring now to the drawings, and particularly to FIG. 1, a harvesting header for use with an agricultural combine harvester (not shown) is seen generally at 10. As is known in the art, the harvesting header 10 is mounted in a cantilevered manner on a feederhouse (not shown) of the combine harvester at a center area 14 of the harvesting header 10. The illustrated harvesting header 10 shown here is a row crop header designed to harvest multiple rows of corn simultaneously. However, one skilled in the art will understand that harvesting headers for use in harvesting any row crops may utilize concepts described herein without departing from the scope of the invention. As best seen in FIG. 2, row units 20 that may be of conventional construction are arranged in side-by-side relationship on the harvesting header 10. Although sixteen row units 20 are shown here, the harvesting header 10 may have any number of such units, in side-by-side relationship, across its width. Each row unit 20 is desirably constructed and operated in a substantially identical manner through any known means. The row units 20 may have a removable snout or divider 22 hingedly coupled to the front of each of the row units 20.

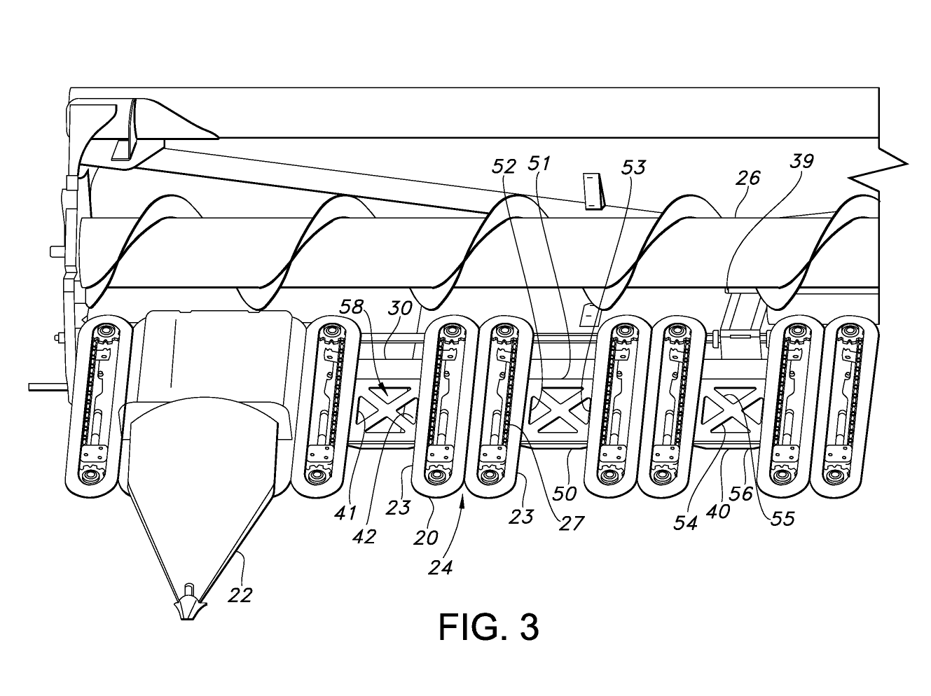

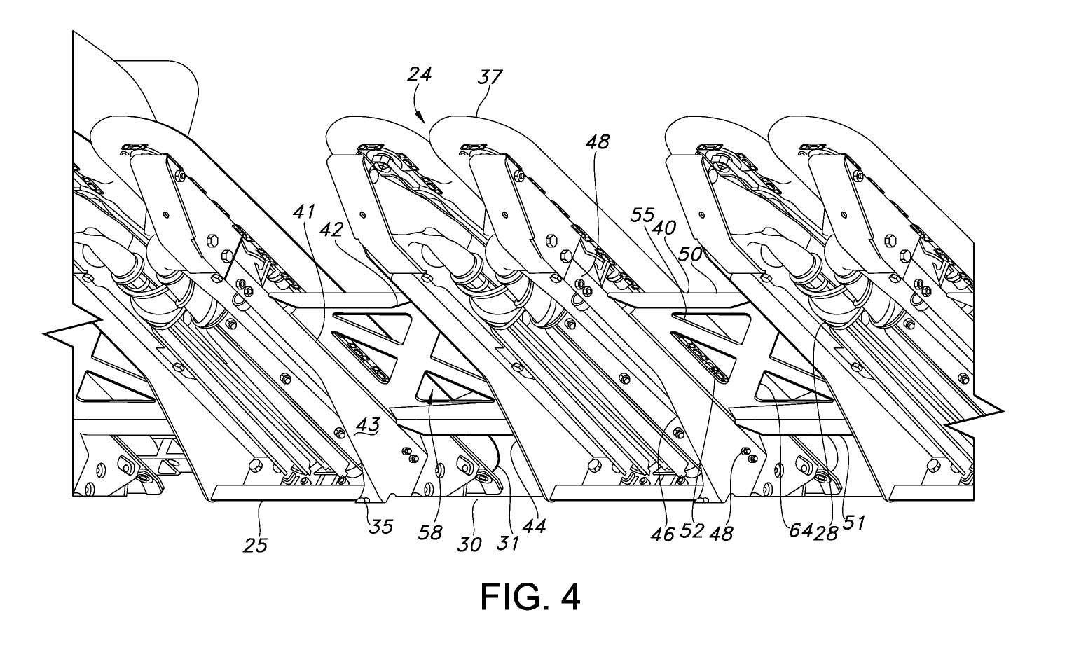

Turning to FIGS. 3 and 4, the row units 20 are have two arms 23 extending from a base 25. Corn stalks are drawn into a slot 24 formed between the two arms 23 of the row unit 20, such as with gathering chains 27. Snapping rolls 28 (FIG. 4) pull the corn stalks downwardly through the slot 24 and the ears of corn are stripped off of the stalks as the stalks are pulled downwardly. The ears of corn stripped from the stalks are carried by an auger 26 (FIG. 1) toward the feederhouse. The collected ears are then carried rearwardly and upwardly into a threshing assembly (not shown) of the combine harvester as known in the art.

The row units 20 are mounted on a tool bar 30 that extends transversely across the width of the header 10. As best seen in FIG. 4, the base 25 at a proximal end 31 of each row unit arm 23 is attached to the tool bar 30 with bolts 35 or other suitable fasteners. Distal ends 37 of the row unit arm 23 extend away from the tool bar 30 forming the slot 24 between the generally parallel row unit arms 23. The gathering chains 25 and snapping rolls 27 are driven by a rotating row unit shaft 32 which extends transversely of the row units 20 over the width of the harvesting header 10. The row unit shaft 32 is drivingly connected to each row unit 20 through a gear box assembly 39 best seen in FIG. 3. Gear box assembly 39 may be of any known means.

According to the invention, an inner row brace 40 is positioned between adjacent row units 20 along the toolbar 30. Opposing sides 41, 42 of the inner row brace 40 are attached to facing outer sides 43, 44 of row unit arms 23 of adjacent row units 20. The inner row brace 40 is positioned forward of the tool bar 30 such that it is between the distal end 37 and proximal end 31 of the row unit arm 23 near its middle. In the illustrated embodiment, the inner row brace 40 is attached to a flange 46 extending from the row unit arm 23 with bolts 48. However, other means of attaching the inner row brace 40 to the row unit arms 23 may be used using sound engineering judgment. The inner row brace 40 is oriented to reduce rearward flexing of the toolbar 30 in the area between the row units 20 and since it is attached to the row unit arms 23, the inner row braces 40 allow the row unit base 25 and gear box assemblies 39 to aid in stiffening the tool bar 30. It can be seen that the inner row brace 40 and row units 20 form a continuous supporting structure for the tool bar 30 having a path through 1) an inner row brace 40, 2) the first row unit arm 23, the row unit base 25 and the other row unit arm 23 of a first row unit 20, 3) a second inner row brace 40, and 4) the row unit arm 23, row unit base and other row unit arm 23 of a second row unit 20.

The inner row brace 40 may be formed as a truss structure especially designed to provide structural support for the toolbar 30 against forces that would tend to bend the toolbar 30 rearward. In the illustrated embodiment, the inner row brace 40 is substantially rectangular with end members 50, 51 parallel to the tool bar 30 and side members 52, 53 perpendicular to the tool bar 30. Diagonal compression members 54, 55 connect opposing junctions of the end members 50, 51 and side members 52, 53. In the illustrated embodiment, the inner row brace 40 is laser cut or punched from a single plate to form the end, side and diagonal members 50-55. However, one skilled in the art will understand that the inner row brace 40 may be formed with separate members attached by welding, riveting or other means. Desirably, the end members 50, 51 have a downward flange 56 to provide added rigidity. Desirably, the inner row brace 40 has openings 58 between the end, side and diagonal members 50-55 to discourage build-up of trash on the brace 40 by allowing the trash to fall through the brace 40.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A harvesting header for use with a row crop harvesting machine, the harvesting header comprising:
a tool bar extending across the full width of the header;
a plurality of row units attached to the tool bar, each row unit comprising a pair of elongated row unit arms extending from said tool bar and forming a stalk-receiving slot between facing inner sides of said pair of row unit arms, said row unit arms having outer sides facing away from the stock-receiving slot; and
a plurality of inner row braces, each inner row brace being positioned forward of the tool bar and between an adjacent pair of said plurality of row units, wherein a first side of the inner row brace is attached to one of the outer sides of one of the row unit arms of one of said plurality of row units and an opposing side of the inner row brace is attached to one of the outer sides of one of the row unit arms of an adjacent row unit.

2. The harvesting header of claim 1 wherein the plurality of inner row braces and plurality of row units comprise a continuous supporting structure for the tool bar having a path through 1) an inner row brace, 2) a first row unit arm, the row unit base and the other row unit arm of a first row unit, 3) a second inner row brace, and 4) the row unit arm, row unit base and other row unit arm of a second row unit.
